(19) United States
(12) Patent Application Publication
(10) Pub. No.: US 2004/0170539 A1
(43) Pub. Date: Sep. 2, 2004

(54) Filter matrix and casings

(76) Inventors: Michael Quinn, Oakville (CA); Donald Donoahue, Oakville (CA)

Correspondence Address: KEYSER MASON BALL, LLP, FOUR ROBERT SPECK PARKWAY, SUITE 1600, MISSISSAUGA,, ON, L4Z 1S1, CA

(21) Appl. No.: 10/789,872

(22) Filed: Feb. 27, 2004

Related U.S. Application Data
(63) Continuation-in-part of application No. 10/226,336, filed on Aug. 23, 2002.

(51) Int. Cl. B01D 53/34

(52) U.S. Cl. 422/177

(57) ABSTRACT

A filter matrix is provided which substantially overlies a broiler at a selective distance therefrom for reducing volatile particulate matter and organic compounds in broiler smoke. The filter matrix comprises at least one filter screen layer horizontally disposed above the broiler for arresting the broiler frame, and a stack of at least two expanded metal filter layers, the first of which is contiguous to the filter screen layer which is directly above the broiler. Each of the filter screen layers, and each of the expanded metal filter layers have a plurality of apertures defined therein arranged in an array, and the layers are stacked in such a manner that when the broiler smoke is passing through the filter matrix, the pathway of the broiler smoke is labyrinthine. The filter matrix may be mounted in a frame. A plurality of frames may be removably mounted in a casing, or hinged together for easy cleaning.

### CROSS REFERENCE

This application is a continuation-in-part of U.S. patent application Ser. No. 10/226,336, filed on Aug. 23, 2002.

### FIELD OF THE INVENTION

This invention relates to filters, and particularly relates to a filter matrix substantially overlying cooking equipment at a selective distance therefrom, for reducing volatile cooking smoke, particulate matter and organic compounds in cooking smoke.

### BACKGROUND

The use of filters for reducing volatile cooking smoke particulate matter and organic compounds in cooking smoke emissions has, of course, been known for many years. Typically, the filters are placed at a selective distance from the source of the cooking smoke emissions and that the filters substantially overlie the broiler source.

The use of filters for reducing volatile broiling smoke particulate matter and organic compounds in cooking smoke emissions has, of course, been known for many years. Typically, the filters are placed at a selective distance from the source of the cookiung smoke emissions and that the filters substantially overlie the cooking source.

In many instances, during food preparation, the burning of organic materials including fats, proteins, and/or carbohydrates generate large amounts of smoke. Particularly in restaurants, and especially fast food restaurants, where the preferred method of cooking is broiling by using such cooking devices as broilers and fryers, large amounts of carbon monoxide, organic vapors and aerosols from the emissions of broiling fatty food, such as fatty hamburgers or the like, may be generated which can cause environmental, health and fire hazard. In order to subside the amount of broiling smoke generated, it is common practice to blow large amounts of air into and through the kitchens such that the smoke can escape through exhaust hoods and chimneys to the outside environment. This method of diluting the broiling smoke is expensive as heating or cooling consumes large amount of electrical energy. In fact, blowing the smoke away from the source simply transfers the smoke from indoors to outdoors, it does not reduce the amount of particulate matter and organic compounds found in broiling smoke.

In order to improve the air we breathe, it is important to reduce the broiling smoke emissions from broilers and other cooking equipment at the source.

Several typical prior art filter matrices are now described. They include BAR-ILAN's U.S. Pat. No. 5,431,887, published Jul. 11, 1995, which teaches a catalytic assembly which is disposed above the broiling area of a fat food broiler. The assembly is intended to enable the catalytic oxidation of volatile broiling smoke organic contaminants. The catalytic oxidation unit comprises a filter screen and a coating for the filter screen. In fact, one of the stated objectives of the inventor is to provide the adhering of a coating to a metallic or similar substrate that serves as a flame arrester and dispersing screen. This screen (or filter) may be an open pore screen, an expanded metal sheet, or the like. The coating on the screen is capable of adsorbing and retaining small amounts of particulate found in the hot broiler emissions as they are directed upwards through the filler. It is apparent from the teachings of BAR-ILAN that the catalytic oxidation unit provided has a single filter screen.

In another U.S. Pat. No. 5,556,819 issued also to the above inventor on Sep. 17, 1996, a method of making a flame arresting and contaminant-absorbing filter apparatus is taught. This patent is a Divisional application of the previously described patent.

In yet another U.S. Pat. No. 5,693,298 issued to the above inventor BAR-ILAN on Dec. 2, 1997, a catalytic assembly positioned above the broiling area of a fat food broiler is taught. This patent is a Divisional application of the issued U.S. Pat. No. 5,556,819. The inventor teaches a method of catalytic abatement of emissions comprising the steps of arresting and dispersing the fatty food broiling flames using a low pressure drop and flame arresting porous filter, passing the emissions through the catalyst positioned over the broiler, adsorbing the salt and phosphorous emissions from the fatty food on the filter, and oxidizing the broiler emissions using a catalyst. The inventor also teaches a binder chosen from the group consisting of titania, zirconia, and ceria.

In U.S. Pat. No. 5,599,509 issued to TOYAO et al. on Feb. 4, 1997, the inventors teach a metal catalyst converter comprising of a metal catalyst carrier which holds the catalyst in a honeycomb shaped filter. The honeycomb body is created by alternately winding a flat sheet and a corrugated sheet together. A slit matrix, having a plurality of slits formed on the flat sheet, the corrugated sheet, or both, is located along a specific section of the filter. The slit matrix extends longitudinally the entire length of the metal sheets and vertically through approximately half the sheet, thus forming a low heat capacity area. The slit matrix, when in its rolled honeycomb form is arranged on the upstream side of the exhaust.

In U.S. Pat. No. 5,622,100 issued to KING et al. on Apr. 22, 1997, the inventors teach a smoke abatement assembly which is designed to overlie a cooking device such as a broiler or flyer cooking system in a commercial restaurant or the like. The low-pressure flame arrester is positioned above the cooking area and has the dual purpose of mixing the smoke and arresting the flames. The performance of the catalysts within the flame arrester are dependent on the space velocity which is defined as the volume of gaseous liquid flowing through the catalyst per hour divided by the catalyst volume. The critical range of flow velocity as determined by the inventors is between 30 feet and 80 feet per second. The solid inorganics present in the broiler emissions pass through the flame arrester. Furthermore, the inventors teach a short and large diameter catalyst region without the need for supplementary heating or fans. An objective of the teachings of the inventors is to substantially equalize the cooking area and the catalyst flow area so as to eliminate hot spots, and to achieve a slow and uniform smoke flow through the catalyst. A typrical catalyst filter structure is a honeycomb structure with no less than 25 cells and no more than 300 cells per inch with honeycomb walls approximately 5 millimetres thick.

Finally, in U.S. Pat. No. 5,821,194 issued to IN on Oct. 13, 1998, the inventor teaches a catalyst for purifying the exhaust gas of vehicles, where the catalyst is formed from a series of layers. The catalyst is constructed from a metallic corrugated substrate formed in a scroll and engaged with a flat substrate, an intermediate layer of ceramic provided on both the flat and corrugated substrates, and a catalytic layer provided on the intermediate layer. This patent also teaches a plurality of holes formed in the corrugated substrate and flat substrates and filled with the intermediate layer of ceramic. The exhaust gas passes through the cells formed between the metallic substrates, and moves therethrough. The gas may diffuse into adjacent cells through the holes formed on the flat substrate and on the corrugated substrate. This increases the purification efficiency of the exhaust gas passing through the substrate.

### SUMMARY

In accordance with one aspect of the present invention, there is provided a filter matrix substantially overlying cooking equipment at a selective distance therefrom for reducing volatile particulate matter and organic compounds in cooking smoke.

The filter matrix of the present invention comprises at least one filter screen layer horizontally disposed above the broiler for arresting the broiler frame. and a stack of at least two expanded metal filter layers. the first of which is contiguous to the filter screen layer which is directly above the broiler.

Each of the at least one filter screen layer is flat and has a plurality of pre-determined apertures defined therein arranged in an array for the passage of cooking smoke therethrough. Generally, each of the apertures is diamond-shaped.

Also, each of the expanded metal filter layers has a plurality of predetermined apertures defined therein arranged in an array for the passage of broiler smoke therethrough. Furthermore, each of the apertures in each of the expanded metal filter layers is diamond-shaped defined by four walls which are inclined at an angle.

Each of the expanded metal filter layers has a major axis and a minor axis such that when the expanded metal filter layers are stacked. The major axis of one of the expanded metal filter layers is perpendicular to the major axis of the next adjacent expanded metal filter layer.

When the broiler smoke is passing through the filter matrix, the pathway of the broiler smoke is labyrinthine.

Typically, the four walls defining each of the apertures in each of the expanded metal filter layers is inclined at an angle between 30 to 70 degrees.

The filter screen layer is manufactured from steel. The expanded metal filter layer is manufactured from materials chosen from the group of materials consisting of iron, chromium, aluminum, yttrium, zirconium, and combinations and mixtures thereof.

The filter screen layer has a catalytic coating, thereon. Typically, the catalytic coating on the filter screen layer has a precious metal catalyst.

Moreover, the expanded metal filter layer has a catalytic coating thereon. Typically, the catalytic coating on the expanded metal filter layer has a precious metal catalyst.

The filter screen layer and/or the expanded metal filter layer may be electropolished

Each of the filter screen layers has a porosity of between 50% and 70%, or more prefereably 62%. Furthermore, each of the expanded metal filter layers has a porosity of between 30% and 50%, or more prefereably 42%.

Typically the filter matrix functions from a range of 150° F. to 1100° F. at a ventilation rate of 50 to 3600 Feet per minute.

In keeping, with one aspect of the present invention, a stack of at least two expanded metal filter layers is sandwiched between two filter screen layers.

In keeping, with another aspect of the present invention, the filter matrix is mounted in a frame.

A plurality of filter matrix frames may be mounted in a casing from which they may be easily removed. The filter matrix frames may alternatively be hingedly connected to one another.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is a side elevation view of a filter matrix substantially overlying a broiler at a selective distance therefrom;

FIG. 2 is a top view of a portion of filter screen layer;

FIG. 3 is a top view of an expanded metal filter layer;

FIG. 4 is a side sectional view of a stack of expanded metal filter layers;

FIG. 5 is a front elevation view of a filter matrix mounted in a frame;

FIG. 6 is a perspective view of a casing for at least one framed filter matrix as shown in FIG. 5;

FIG. 7 is a perspective view of a framed filter matrix sliding into the casing of FIG. 5;

FIG. 8 is a perspective view of a hinged filter matrix structure in an expanded position; and

FIG. 9 is a top view of the hinged filter matrix structure of FIG. 8 in a compressed position.

### DETAILED DESCRIPTION

The novel features which are believed to be characteristic of the present invention, as to its structure, organization, use and method of operation. together with further objectives and advantages thereof, will be better understood from the following discussion.

As noted above, a feature of the present invention is to provide a filter matrix substantially overlying a broiler or other form of cooking equipment (e.g. fryer, grill etc.) at a selective distance therefrom for reducing volatile particulate matter and organic compounds in broiler or other cooking smoke. It has been found that at least 85% of hydrocarbons and particulate matter may be destroyed by using such a filter matrix. Typically, the filter matrix is located 4 to 10 inches from the broiler smoke emission source. Furthermore, the filter matrix generally functions from a range of 300° F. to 1100° F. at a ventilation rate of 50 to 3600 feet per minute. With the use of titanium dioxide in combination with an ultraviolet filter, the filter matrix may function from 15⁰° F. to 1100° F.

Turning first to FIG. 1, the filter matrix 10 comprises at least one filter screen 12 horizontally disposed above the broiler 14 for arresting the broiler frame 16, and a stack of at least two expanded metal filter layers 18a and 18b. In practice, depending on the hood configuration, the filter matrix 10 may be mounted at an angle above the cooking equipment. As is shown in the figure, the first of the expanded metal filter layer 18a is contiguous to the filter screen lager 12 which is directly above the broiler 10. When the broiler smoke is passing through the filter matrix 10, the pathway of the broiler smoke is labyrinthine, as is shown by dashed arrow 1.

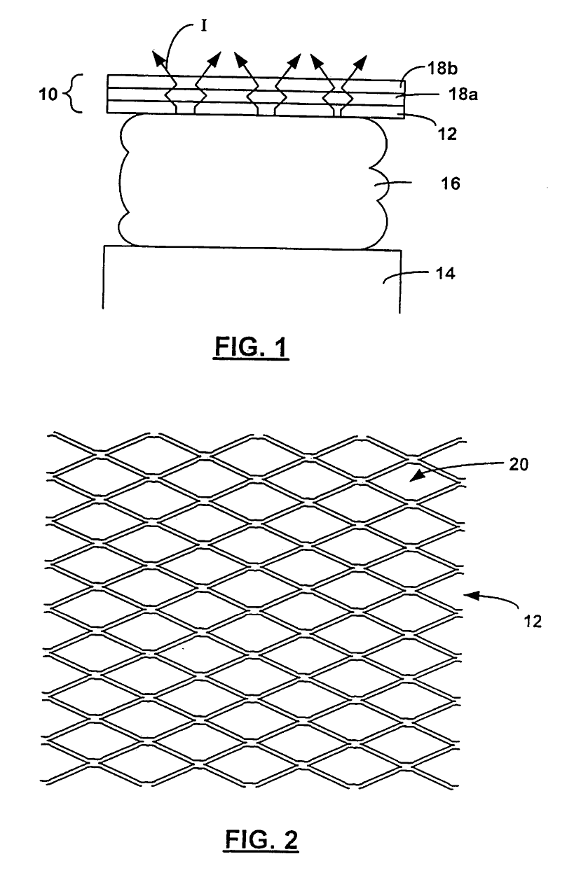

In FIG. 2, a top view of a filter screen layer 12 is shown. The filter screen layer 12 is flat and has a plurality of pre-determined apertures 20 defined therein arranged in an array for the passage of broiler smoke therethrough. Each of the apertures 20 is diamond-shaped. The term porosity in this application shall refer to the percentage of the filter area through which particles may pass unimpeded in a perpendicular direction (i.e. the precentage of the entire area which is open). The porosity of the filter screen layer 12 may vary significantly, depending on the application, distance to the cooking equipment etc. The inventors have found that a porosity of between 50% and 70% is preferable. More preferably, a porosity of 62% may be used.

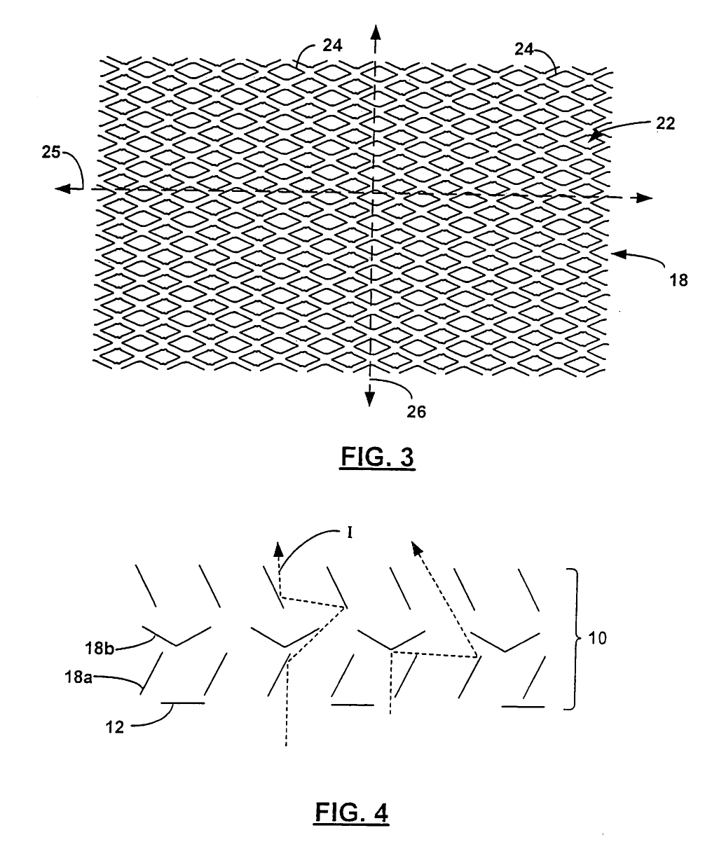

As shown in FIG. 3, the expanded metal layer 18 also has a plurality of pre-determined apertures 22 defined therein arranged in an array for the passage of broiler smoke therethrough. Each of the apertures 22 in the expanded metal filter layer 18 is diamond-shaped defined by four walls 24 which are inclined at an angle. Typically, the four walls 24 defining each of the apertures 22 in each of the expanded metal filter layers 18 is inclined at an angle between 30 to 70 degrees. The porosity of the filter screen layer 12 may vary significantly, depending on the application, distance to the cooking equipment etc. The inventors have found that a porosity of between 30% and 50% is preferable. More preferably, a porosity of 42% may be used.

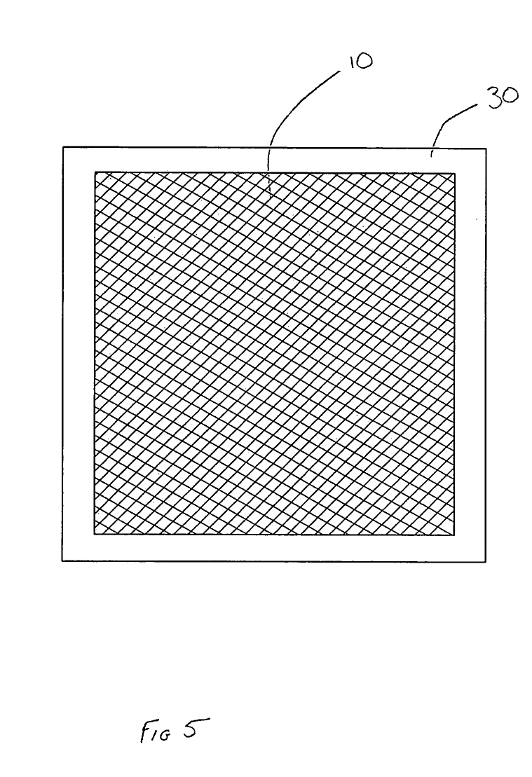

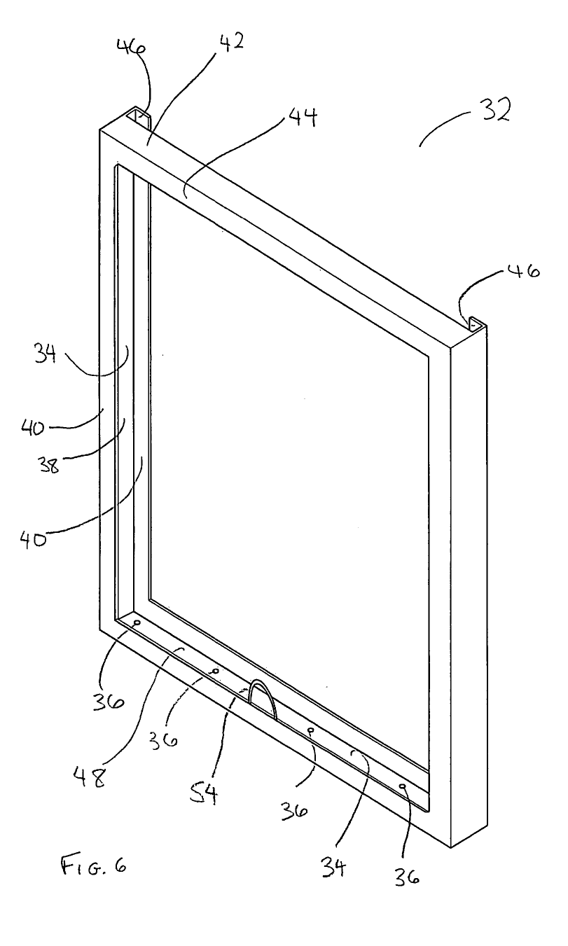

Furthermore, each of the expanded metal filter layers 18 has a major axis 25 and a minor axis 26 such that when the expanded metal filter layers 18 are stacked, the major axis 25 of one of the expanded metal filter layers 18a is perpendicular to the major axis 25 of the next adjacent expanded metal filter layer 18b. Indeed, when the broiler smoke is passing through the filter matrix 10, the pathway of the broiler smoke is labyrinthine, as is shown by dashed arrow 1 (FIG. 4).

Typically, the filter screen layer 12 is manufactured from steel such as stainless steel. The expanded metal filter layer 18 is manufactured from alloys of the metals chosen from the group of iron, chromium, aluminum, yttrium, zirconium, titanium dioxide and combinations and mixtures thereof. Titanium dioxide filters layers may be used in combination with an ultraviolet filter.

In keeping with one aspect of the present invention, the filter screen layer 12 has a catalytic coating thereon. The catalytic coating may be a precious metal catalyst. In keeping, with another aspect of the present invention, the expanded metal filter layer 18 has a catalytic coating thereon, and the catalytic coating is a precious metal catalyst. The use of precious metal catalyst for the intended purposes herein is well known to those skilled in the art. It is important to note that it is possible for a filter matrix 10 with filter screen layer 12 and expanded metal filter layer 18 both having catalytic coating thereon.

Alternatively, titanium dioxide or other non-precious metal catalysts may be used for the catalytic coating. Titanium dioxide is most useful when the

Alternatively, or in addition, filter screen layer 12 and/or expanded metal filter layer 18 may be electropolished. Electropolishing acts to smooth the surfaces of the layers. Grease particles do not adhere as easily to electropolished surfaces and will slide off the layers into a grease catching structure.

Alternatively, or in addition, filter screen layer 12 and/or expanded metal filter layer 18 may be impregnated or coated with a non-stick compound. Grease particles do not adhere as easily to such surfaces and will slide off the layers into a grease catching structure. Such non-stick compounds include fluoropolymers such as PTFE or a combination of polymers or metals to which grease tends not to adhere.

In one embodiment of the present invention, a stack of at least two expanded metal filter layers 18 is sandwiched between two filter screen layers 12.

The filter matrix 10 may consist of two to sixteen layers of expanded metal filter layers 18 sandwiched between two outer filter screen layers 12. Each of the apertures 22 in each of the expanded metal filter layers 18 is defined by the four walls 24 which are inclined at an angle of 60 degrees such that the broiler smoke passing through each of the apertures 22 comes in contact with the material surface. The apertures 22 of the expanded metal filter layer 18, and the apertures 20 of the filter screen layer 12 have been dimensioned such that back pressure of the broiler smoke is minimized. It has been found that for a filter matrix 10 having eight or more layers, a significant reduction of volatile particulate matter and organic compounds in broiler smoke may also be achieved in the absence of a catalytic coating on the layers.

The filter matrix 10 may also consist of two layers of expanded metal filter layers 18 sandwiched between two outer filter screen layers 12. FIG. 5 shows such a filter matrix mounted within a frame 30. The borders of frame 30 act to keep the layers of the filter matrix 10 together. A filter matrix with this configuration has the advantage of being more easily cleaned than one with additional metal filter layers 18. The arrow 1 in FIG. 4 which shows the labyrinthine path for the broiler smoke also shows why it may be difficult for water to penetrate beyond a few expanded metal filter layers during cleaning.

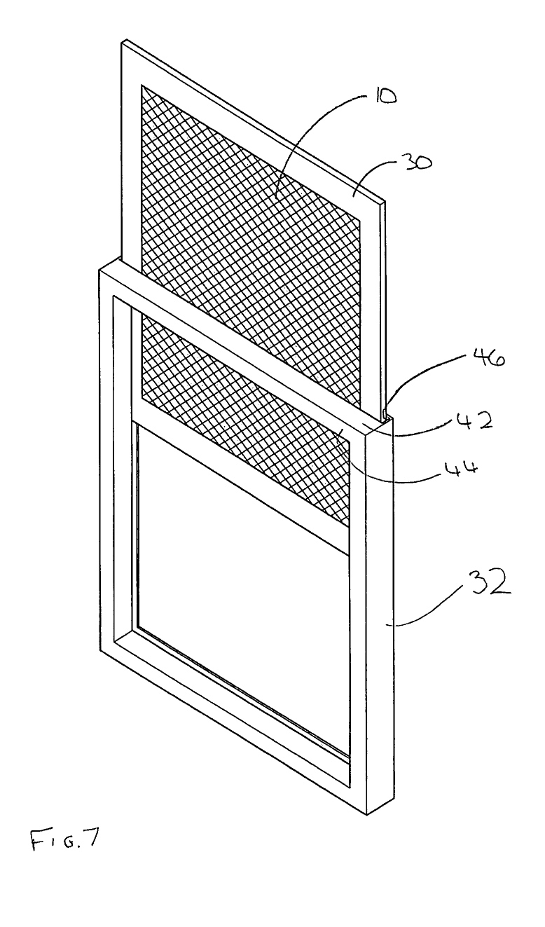

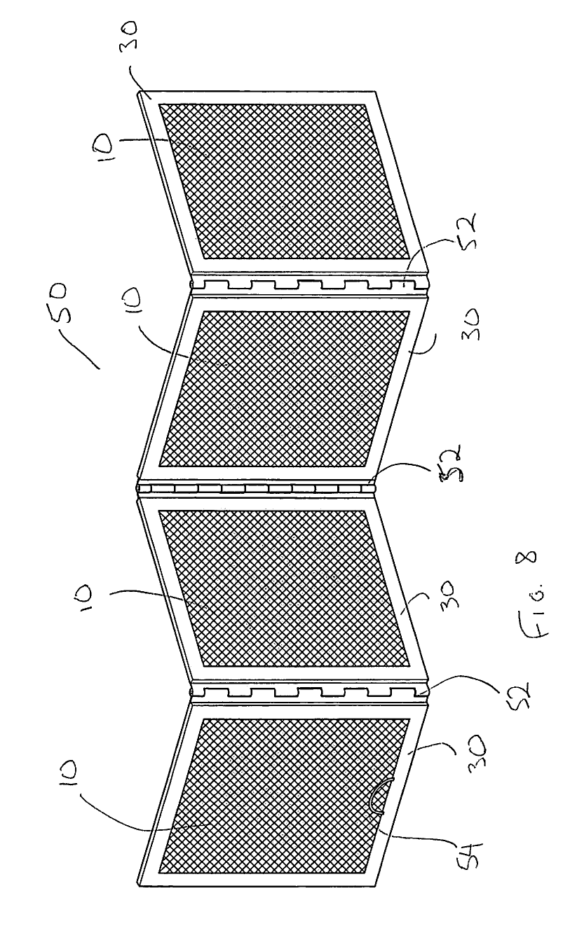

FIG. 6 and shows a casing 32 in which a plurality of filter matrices 10 in frames 30. Casing 32 is a generally rectangular structure with internal channels 34 and drain holes 36. Each internal channel comprises an end portion 38 and a pair of opposed side portions 40. However, the uppermost end portion 42 is provided with only one side portion 44. As a result, filter matrices 10 may be placed into, and removed from, casing 32 by sliding them into the resulting opposed pair of slots 46, as shown in FIG. 7. Casing 32 may also be provided with a grip member 54 for easy removal of casing 32 from a ventilation hood. Grease which accumulates in the filter may run down the filter matrices 10, collect in a lower internal channel 48 (opposite to uppermost end portion 42) and drip out the drain holes 36. Appropriate grease catching structures may then be incorporated into the ventilation hood to receive the dripping grease. Casing 32 is advantageous as it can incorporate multiple filter matrices 10, which can be individually removed and placed in a dishwasher for easy cleaning.

The filter matrices 10 mounted within casing 32 need not be identical to one another. For example, the outermost filter matrices may include filter screen layers, while the innermost filter matrices may not. However, care should be take in such situations to ensure that, after removal for cleaning, the filter matrices are replaced in the correct order.

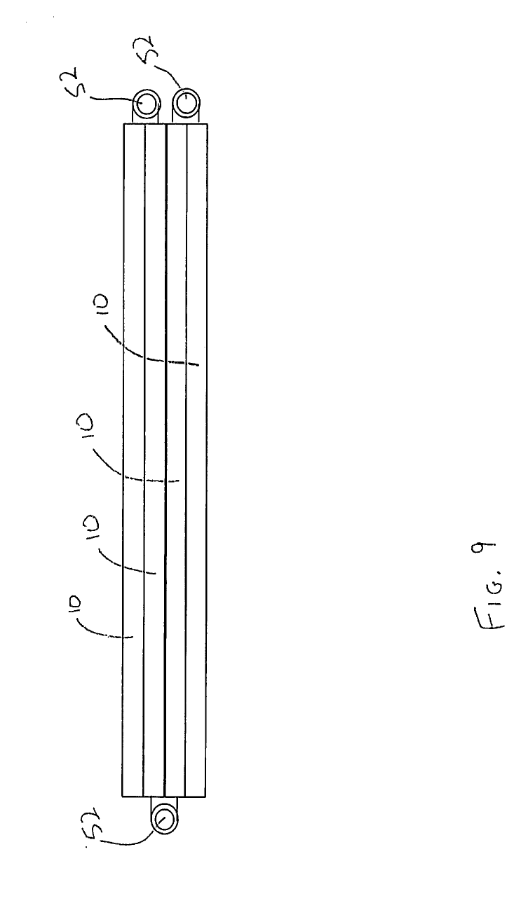

FIG. 8 shows a matrix structure 50 consisting of four filter matrices 10 mounted in frames 30 (such as that shown in FIG. 5 and described above) joined together edge-to-edge with piano hinges 52. The filter matrices may be folded together such that they are stacked on top of one another and placed within a ventilation hood, as shown from above in FIG. 9. When matrix structure 50 is removed from the ventilation hood, the filter matrices may be spread apart, as shown in the figure, and placed in a dishwasher for cleaning.

The filter matrices in matrix structure 50 also need not be identical to one another. For example, the outermost filter matrices may include filter screen layers, while the innermost filter matrices may not. In fact, the filter matrices may not even include any filter screen layers. Since the frames are hinged together in a particular order, the problem of placing the filter matrices in the correct order is avoided.

In addition, both matrix structure 50 and casing 32 may be provided with a handle or grip member 54 to easily remove the structures from the ventilation hood for cleaning.

Other modifications and alterations may be used in the design and manufacture of the apparatus of the present invention without departing from the spirit and scope of the accompanying claims.

Throughout this specification and the claims which follow, unless the context requires otherwise, the word ‘comprise’, and variations such as ‘comprises’ or ‘comprising’, will be understood to imply the inclusion of a stated integer or step or group of integers or steps but not to the exclusion of any other integer or step or group of integers or steps.

1. A filter matrix substantially overlying cooking equipment at a selective distance therefrom for reducing volatile particulate matter and organic compounds in cooking smoke, said filter matrix comprising:
at least one filter screen layer, said at least one filter screen layer being flat and having a plurality of pre-determined apertures defined therein arranged in an array for the passage of cooking smoke therethrough, and wherein each of said apertures is diamond shaped; and
a stack of at least two expanded metal filter layers, the first of which is contiguous to said filter screen layer, each of said expanded metal filter layers having a plurality of predetermined apertures defined therein arranged in an array for the passage of cooking smoke therethrough;
wherein each of said apertures in each of said expanded metal filter layers is diamond-shaped defined by four walls which are inclined at an angle to a plane defined by the expanded metal filter layers; and
wherein each of said expanded metal filter layers has a major axis and a minor axis such that when said expanded metal filter layers are stacked, said major axis of one of said expanded metal filter layers is perpendicular to the major axis of the next adjacent expanded metal filter layer:
whereby when the cooking smoke is passing through said filter matrix, the pathway of the cooking smoke is labyrinthine.

2. The filter matrix according to claim 1, wherein said four walls defining each of said apertures in each of said expanded metal filter layers is inclined at an angle between 30 to 70 degrees.

3. The filter matrix according to claim 1, wherein said filter screen layer is manufactured from steel.

4. The filter matrix according to claim 1, wherein said expanded metal filter layer is manufactured from materials chosen from the group of materials consisting of iron, chromium, aluminum, yttrium, zirconium, titanium dioxide and combinations and mixtures thereof.

5. The filter matrix according to claim 1, wherein said filter screen layer has a catalytic coating thereon.

6. The filter matrix according to claim 5, wherein said catalytic coating is a precious metal catalyst.

7. The filter matrix according to claim 5 wherein said catalytic coating is titanium dioxide.

8. The filter matrix according to claim 1, wherein said expanded metal filter layer has a catalytic coating thereon.

9. The filter matrix according to claim 8, wherein said catalytic coating is a precious metal catalyst.

10. The filter matrix according to claim 8 wherein said catalytic coating is titanium dioxide.

11. The filter matrix according to claim 1, wherein said filter screen layer has an electropolished surface.

12. The filter matrix according to claim 1, wherein said filter screen layer has a non-stick coating.

13. The filter matrix according to claim 1, wherein said expanded metal filter layer has an electropolished surface.

14. The filter matrix according to claim 1, wherein said expanded metal filter layer has a non-stick coating.

15. The filter matrix according to claim 1, wherein each of said filter screen layers has a porosity between 50% and 70%.

16. The filter matrix according to claim 1, wherein each of said filter screen layers has a porosity between 60% and 65%.

17. The filter matrix according to claim 1, wherein each of said filter screen layers has a porosity of 62%.

18. The filter matrix according to claim 1, wherein each of said expanded metal filter layers has a porosity of between 30% and 50%.

19. The filter matrix according to claim 1, wherein each of said expanded metal filter layers has a porosity of between 40% and 55%.

20. The filter matrix according to claim 1, wherein each of said expanded metal filter layers has a porosity of 42%.

21. The filter matrix according to claim 1, wherein said filter matrix functions from a range of 300° F. to 1100° F. at a ventilation rate of 50 to 3600 feet per minute.

22. The filter matrix according to claim 1. wherein a stack of at least two expanded metal filter layers is sandwiched between two said filter screen layers.

23. The filter matrix according to claim 1, wherein said filter matrix is mounted in a frame.

24. A filter matrix structure substantially overlying cooking equipment at a selective distance therefrom for reducing volatile particulate matter and organic compounds in cooking smoke, said filter matrix structure comprising:
at least one filter matrix having:
a stack of at least two expanded metal filter layers, each of said expanded metal filter layers having a plurality of predetermined apertures defined therein arranged in an array for the passage of cooking smoke therethrough;
wherein each of said apertures in each of said expanded metal filter layers is diamond-shaped defined by four walls which are inclined at an angle to a plane defined by the expanded metal filter layers;
wherein each of said expanded metal filter layers has a major axis and a minor axis such that when said expanded metal filter layers are stacked, said major axis of one of said expanded metal filter layers is perpendicular to the major axis of the next adjacent expanded metal filter layer; and
wherein at least one of said filter matrices has at least one filter screen layer, said at least one filter screen layer being flat and contiguous to one of said expanded metal filter layers and having a plurality of pre-determined apertures defined therein arranged in an array for the passage of cooking smoke therethrough, and wherein each of said apertures is diamond shaped; and
a casing for slidably receiving said at least one filter matrix.

25. A filter matrix structure as claimed in claim 24, wherein said casing is provided with at least one channel positioned to receive said at least one filter matrix.

26. A filter matrix structure as claimed in claim 24, wherein said casing is provided with a slot for slidably receiving said at least one filter matrix.

27. A filter matrix structure as claimed in claim 24, wherein said casing is provided with at least one drain hole.

28. A filter matrix structure substantially overlying cooking equipment at a selective distance therefrom for reducing volatile particulate matter and organic compounds in cooking smoke, said filter matrix structure comprising:
at least two filter matrices hingedly mounted to one another, said filter matrices having:
a stack of at least two expanded metal filter layers, each of said expanded metal filter layers having a plurality of predetermined apertures defined therein arranged in an array for the passage of cooking smoke therethrough;
wherein each of said apertures in each of said expanded metal filter layers is diamond-shaped defined by four walls which are inclined at an angle to a plane defined by the expanded metal filter layers; and
wherein each of said expanded metal filter layers has a major axis and a minor axis such that when said expanded metal filter layers are stacked, said major axis of one of said expanded metal filter layers is perpendicular to the major axis of the next adjacent expanded metal filter layer.

29. The filter matrix structure as claimed in claim 28, wherein said four walls defining each of said apertures in each of said expanded metal filter layers is inclined at an angle between 30 to 70 degrees.

30. The filter matrix according to claim 28, wherein said expanded metal filter layer is manufactured from materials chosen from the group of materials consisting of iron, chromium, aluminum, yttrium, zirconium, titanium dioxide and combinations and mixtures thereof.

31. The filter matrix according to claim 28, wherein said expanded metal filter layer has a catalytic coating thereon.

32. The filter matrix according to claim 35, wherein said catalytic coating is a precious metal catalyst.

33. The filter matrix according to claim 35 wherein said catalytic coating is titanium dioxide.

34. The filter matrix according to claim 28, wherein said expanded metal filter layer has an electropolished surface.

35. The filter matrix according to claim 28, wherein said expanded metal filter layer has a non-stick coating.

36. The filter matrix structure as claimed in claim 28, wherein each of said expanded metal filter layers has a porosity of between 30% and 50%.

37. The filter matrix structure as claimed in claim 28, wherein each of said expanded metal filter layers has a porosity of between 40% and 55%.

38. The filter matrix structure as claimed in claim 28, wherein each of said expanded metal filter layers has a porosity of 42%.

39. A filter matrix substantially overlying a broiler at a selective distance therefrom for reducing volatile particulate matter and organic compounds in broiler smoke, said filter matrix comprising:
at least one filter screen layer horizontally disposed above the broiler for arresting the broiler flame; and
a stack of at least two expanded metal filter layers, the first of which is contiguous to said filter screen layer which is directly above the broiler;
wherein each of said at least one filter screen layer is flat and has a plurality of pre-determined apertures defined therein arranged in an array for the passage of broiler smoke therethrough and wherein each of said apertures is diamond shaped;
wherein each of said expanded metal filter layers has a plurality of pre-determined apertures defined therein arranged in an array for the passage of broiler smoke therethrough,
wherein each of. said apertures in each of said expanded metal filter layers is diamond-shaped defined by four wails which are inclined at an angle: and
wherein each of said expanded metal filter layers has a major axis and a minor axis such that when said expanded metal filter layers are stacked. said major axis of one of said expanded metal filter lagers is perpendicular to the major axis of the next adjacent expanded metal filter layer:
whereby when the broiler smoke is passing through said filter matrix. the pathway of the broiler smoke is labyrinthine.

40. The filter matrix according to claim 39, wherein said four walls defining each of said apertures in each of said expanded metal filter layers is inclined at an angle between 30 to 70 degrees.

41. The filter matrix according to claim 39, wherein said filter screen layer is manufactured from steel.

42. The filter matrix according to claim 39, wherein said expanded metal filter layer is manufactured from materials chosen from the group of materials consisting of iron, chromium, aluminum, yttrium, zirconium, titanium oxide and combinations and mixtures thereof.

43. The filter matrix according to claim 39, wherein said filter screen layer has a catalytic coating thereon.

44. The filter matrix according to claim 43, wherein said catalytic coating is a precious metal catalyst.

45. The filter matrix according to claim 43, wherein said catalytic coating is titanium dioxide.

46. The filter matrix according to claim 39, wherein said filter screen layer has a non-stick coating.

47. The filter matrix according to claim 39, wherein said expanded metal filter layer has a catalytic coating thereon.

48. The filter matrix according to claim 46, wherein said catalytic coating is a precious metal catalyst.

49. The filter matrix according to claim 46, wherein said catalytic coating is titanium dioxide.

50. The filter matrix according to claim 39, wherein said expanded metal filter layer has a non-stick coating.

51. The filter matrix according to claim 39, wherein each of said filter screen layers has a porosity between 50% and 70%.

52. The filter matrix according to claim 39, wherein each of said filter screen layers has a porosity between 60% and 65%.

53. The filter matrix according to claim 39, wherein each of said filter screen layers has a porosity of 62%.

54. The filter matrix according to claim 39, wherein each of said expanded metal filter layers has a porosity of between 30% and 50%.

55. The filter matrix according to claim 39, wherein each of said expanded metal filter layers has a porosity of between 40% and 55%.

56. The filter matrix according to claim 39, wherein each of said expanded metal filter layers has a porosity of 42%.

57. The filter matrix according to claim 39, wherein said filter matrix functions from a range of 150° F. to 1100° F. at a ventilation rate of 50 to 3600 feet per minute.

58. The filter matrix according to claim 39. wherein a stack of at least two expanded metal filter layers is sandwiched between two said filter screen layers.

59. The filter matrix according to claim 39, wherein said filter matrix is mounted in a frame.
